(19) United States
(12) Patent Application Publication
(10) Pub. No.: US 2026/0217601 A1
(43) Pub. Date: Jul. 30, 2026

(54) BRINE SLUDGE ACTIVATED SILICO-MANGANESE FUME BASED BINARY ALKALI ACTIVATED BINDER

(71) Applicants: SAHARA INTERNATIONAL PETROCHEMICAL COMPANY (SIPCHEM), Dhahran (SA); KING FAHD UNIVERSITY OF PETROLEUM AND MINERALS, Dhahran (SA)

(72) Inventors: Mohammed IBRAHIM, Dhahran (SA); Mohammed MASLEHUDDIN, Dhahran (SA); Sekhar B. MAMILLA, Dhahran (SA); Zaid A. KHALLAF, Dhahran (SA)

(73) Assignees: SAHARA INTERNATIONAL PETROCHEMICAL COMPANY (SIPCHEM), Dhahran (SA); KING FAHD UNIVERSITY OF PETROLEUM AND MINERALS, Dhahran (SA)

(21) Appl. No.: 19/038,644

(22) Filed: Jan. 27, 2025

(51) Int. Cl. C04B 7/13; C04B 7/153; C04B 14/06; C04B 14/28; C04B 28/02; C04B 40/02; C04B 103/00; C04B 103/10; C04B 111/00

(52) U.S. Cl. CPC C04B 7/13; C04B 7/1535; C04B 14/068; C04B 14/28; C04B 28/021; C04B 40/0263; C04B 2103/0006; C04B 2103/10; C04B 2111/00215; C04B 2201/20; C04B 2201/50

(57) ABSTRACT

A method of producing concrete, including: mixing natural pozzolan, silico-manganese fume, a coarse aggregate, and a fine aggregate to form a dry powder; and mixing an alkaline activator with the dry powder to form the concrete, the alkaline activator including sodium silicate and brine sludge, where: a density of the brine sludge is about 100 kg/m³ or more, a ratio of the sodium silicate to the brine sludge is about 2.5 to 1 by mass, and an oxide composition of the brine sludge includes 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

### BACKGROUND

### Field of the Invention

The present disclosure relates to alkali activated binders, cement compositions, mortars, cured compositions thereof, and concretes thereof. The present disclosure also relates to alkali activated binder compositions comprising brine sludge, natural pozzolan, and silico-manganese fume, and methods of making thereof.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The substitution of ordinary Portland cement (OPC) with alternate materials with lower carbon footprint is a main goal of the worldwide concrete industry. The manufacture of OPC generates enormous quantities of carbon dioxide (CO₂), representing about 5-7% of human-made CO₂ emissions. Generally, the manufacture of one ton of OPC releases almost a ton of CO₂ into the atmosphere. With worldwide cement production being about 4.2 billion tons per year, cement manufacturing releases approximately 4 billion tons CO₂ every year.

Additionally, cement is generally the most costly component of concrete. Reducing the amount of cement, typically present in the form of cementitious binders, would significantly reduce the overall costs of forming concrete.

In forming traditional alkaline activated cementitious binders, alkaline compounds, particularly sodium hydroxide and sodium silicate, are used to activate an aluminosilicate material. Sodium hydroxide, also known as caustic soda, is produced industrially through the chlor-alkali process, which involves the electrolysis of a sodium chloride brine. The formation of caustic soda is both energy-intensive and expensive, leading to an average market cost of caustic soda that can be above $1,000 per ton. An industrial by-product of caustic soda production is brine sludge, an alkaline product produced during the purification of the brine used in caustic soda production.

Silico-manganese fume (SiMnF) is an industrial by-product generated in the ferro-alloy manufacturing industry. SiMnF is composed primarily of silica and manganese, with trace amounts of metals and other materials. For every ton of steel production, up to 0.1 ton of SiMnF waste is produced. The silica content of SiMnF makes it a potential candidate as a component of concrete that may have cementitious properties.

Both brine sludge and silico-manganese fume are currently being disposed of in landfills, causing environmental pollution, contaminating ground water and soil, requiring costly environmental mitigation practices, and using up potentially valuable land acreage.

Therefore, methods of reducing the cement content in concrete, such as by replacing cement with more cost-effective and environmentally friendly by-products, is needed. Furthermore, replacing sodium hydroxide activators with more cost-effective and environmentally friendly materials, such as by-products of current industrial processes, is also needed.

### SUMMARY

Some embodiments of the present disclosure provide a method of producing concrete. The method may include: mixing natural pozzolan, silico-manganese fume, a coarse aggregate, and a fine aggregate to form a dry powder; and mixing an alkaline activator with the dry powder to form the concrete, the alkaline activator including sodium silicate and brine sludge, where: a density of the brine sludge is about 100 kg/m³ or more, a ratio of the sodium silicate to the brine sludge is about 2.5 to 1 by mass, and an oxide composition of the brine sludge includes 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

Some embodiments of the present disclosure provide an alkali activated binder, the alkali activated binder including: natural pozzolan; silico-manganese fume; and an alkali activator including sodium silicate and brine sludge, where: a density of the brine sludge is about 100 kg/m³ or more, a ratio of the sodium silicate to the brine sludge is about 2.5 to 1 by mass, and an oxide composition of the brine sludge includes 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

Some embodiments of the present disclosure provide a concrete, the concrete including: the alkali activated binder; a coarse aggregate including crushed limestone; and a fine aggregate including dune sand.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 shows a scanning electron micrograph image of a raw silico-manganese fume, according to some embodiments.

FIG. 2 shows an X-ray diffraction (XRD) pattern of a raw brine sludge, according to some embodiments.

FIG. 3 shows a solution of brine sludge mixed with sodium silicate, according to some embodiments.

FIG. 4 shows de-molded alkali activated concrete (AAC) specimens of varying sizes and shapes, according to some embodiments.

FIG. 5 shows flow of alkali activated mortar mixes, according to some embodiments.

FIG. 6 shows compressive strength development of alkali activated concretes, according to some embodiments.

FIG. 7 shows flexural strength of alkali activated concrete mixtures prepared with brine sludge, according to some embodiments.

FIG. 8 shows modulus of elasticity of alkali activated concrete mixtures prepared with brine sludge, according to some embodiments.

FIG. 9 shows shrinkage strain of alkali activated concrete mixtures prepared by activating natural pozzolan with sodium silicate and sodium hydroxide, according to some embodiments.

FIG. 10 shows shrinkage strain of alkali activated concrete mixtures prepared by activating natural pozzolan with sodium silicate and brine sludge, according to some embodiments.

FIG. 11 shows shrinkage strain of alkali activated concrete mixtures prepared by activating 70% natural pozzolan and 30% silico-manganese fume with sodium silicate and brine sludge, according to some embodiments.

FIG. 12 shows maximum and 28-day drying shrinkage strain of alkali activated concrete mixtures prepared with sodium silicate and brine sludge, according to some embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “natural pozzolan” means a type of naturally occurring aluminosilicate material, generally of volcanic origin that, when reacted with calcium hydroxide in the presence of water, can form a solid material having cementitious properties. Its cementitious properties depend on the amounts of reactive SiO₂ and Al₂O₃ present in the aluminosilicate. The natural pozzolan may be sourced from volcanic rocks, sedimentary clays and shales, opaline cherts, pumicites, and/or diatomaceous earths.

As used herein, the term “cementitious,” “cementitious material,” and the like, means having cement-like properties, including being curable, where curing includes setting, hardening, and/or adhering when combined with other materials, such as coarse and/or fine aggregates, and with water.

As used herein, the term “brine sludge” means an industrial waste product formed in the chlor-alkali process during the production of caustic soda. Brine sludge typically includes multiple components, with main components including calcium carbonate, magnesium hydroxide, and other insoluble salts such as sodium chloride, as well as impurities including silica and clay minerals. Brine sludge has an alkaline pH at least in part due to the presence of Na and Cl in the mixture. At least a part of the alkalinity of brine sludge may come from hydroxide ions. At least a part of the alkalinity may come from Na₂O, BaO and CaO.

Brine sludge is generally a solid by-product which is formed as a precipitate from the coagulation-flocculation process from the treatment of brine solutions in the chlorine industry. In some cases, industrial brine sludge precipitate may be removed from the industrial process in the form of a heavily viscous slurry, which can be dried to form a solid dry brine sludge powder.

Brine sludge may include heavy metals leftover from industrial production. These heavy metals, some of which may be toxic, can be removed from brine sludge before use, such as by sorption with aluminum silicate matrices. The composition of brine sludge varies around the world, and it typically contains a large number of components, with barite, brucite, calcite, illite, quarts and halite phases being phases present in some brine sludges. The elemental composition of brine sludge typically includes Ca, Si, Na, Mg, Al, Cl, P, S, Fe, Ti, Mn and K. Varying functional groups can be present in brine sludge, including carbonate, oxide, siloxane, and hydroxide. Typical particle sizes of brine sludge are in the range of from 100 nm to 1 mm, such as 100 nm to 100 μm, or 1 μm to 500 μm, or 1 μm to 100 μm, or 1 μm to 30 μm.

As used herein, the term “alkali activated binder” means a material having cementitious properties, which is produced by activating an aluminosilicate precursor using an alkaline medium. An alkali activated binder may or may not contain cement as a component.

As used herein, the term “silico-manganese fume,” “SiMnF,” and the like, means an industrial by-product material generated during basic oxygen furnace steel production, generally having an essential oxide composition including SiO₂ and MnO, and other components which may include K₂O and CaO. Manganese (Mn) is an essential component of steels. During steel production, lime, silica, dolomite, and other reagents are added to steel precursor materials at high temperatures, such as 1500° C., in order to oxidize impurities such as carbon and phosphorus, typically present in the precursor materials. SiMnF is generated as a by-product of this high temperature process.

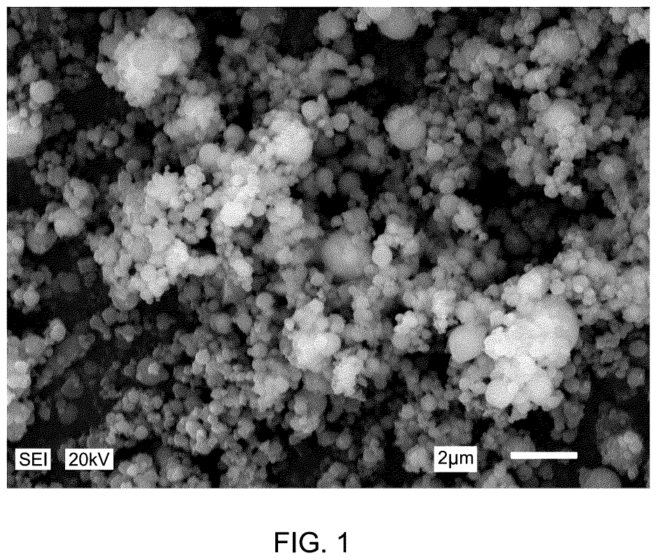

Generally, SiMnF is a solid particulate having an ultrafine particle size, ranging from the nm to micron size. In some embodiments, the SiMnF may have a particle size of less than 50 μm, such as less than 40 μm, less than 30 μm, less than 20 μm, less than 10 μm, less than 1 μm, less than 500 nm, or less than 100 nm. For example, the particle size may be from 10 to 40 μm, from 20 to 30 μm, or from 22 to 27 μm, such as about 25.52 μm. In some embodiments, the SiMnF particles may have a spherical morphology, as shown in the scanning electron micrograph image of FIG. 1.

In some embodiments, the SiMnF may have a BET surface area of 6-10 m²/g, such as 7-9 m²/g, 8-9 m²/g, or about 8.12 m²/g. The SiMnF may have a moisture content of from 0.1% to 1.0%, such as 0.2% to 0.4%, such as about 0.325%. The SiMnF may have a strength activity index of from 70-90%, such as 72-78%, such as about 76.7%.

In some embodiments, the SiMnF may have a specific gravity of from 2.5 g/cc to 3.0 g/cc, such as about 2.6 g/cc, about 2.7 g/cc, about 2.8 g/cc, about 2.9 g/cc, or about 3 g/cc.

In some embodiments, the chemical composition of SiMnF may comprise 12-17 wt % silica (SiO₂), 0.5-3 wt % alumina (Al₂O₃), 1-3 wt % ferric oxide (Fe₂O₃), 3-6 wt % lime (CaO), 3-6 wt % magnesium oxide (MgO), 25-30 wt % potassium oxide (K₂O), 2-10 wt % sulfur trioxide (SO₃), 25-40 wt % manganese oxide (MnO), 0.5-4 wt % sodium oxide (Na₂O), 1-5 wt % chloride (Cl), and 0.25-1.5 wt % zinc oxide (ZnO). The SiMnF may have a loss on ignition (LOI) of from 2-10%, such as about 5.7%.

As used herein, the term “room temperature” means a temperature of from about 20° C. to about 25° C., preferably 25° C.

As used herein, the term “crystallinity,” “crystalline material,” and the like, refers to a material, generally a solid material, where at least some of the atoms, molecules, or ions of the crystalline material have an ordered structure, such as being arranged in a highly ordered, repeating pattern or lattice throughout a crystalline portion of the material. A crystalline material may be partially crystalline, containing one or more crystalline phases that are present in addition to one or more non-crystalline phases, such as amorphous phases that may be solid or liquid. The crystalline and non-crystalline phases may be intermixed in the material. A crystalline material may comprise multiple different crystalline phases, where each phase can independently have the same chemical composition or different chemical compositions.

Some embodiments of the present disclosure are directed to environmentally friendly alkali activated binders, cementitious compositions thereof, and concretes thereof. The alkali activated binders may be formed by activating indigenous natural pozzolan with brine sludge. As used herein, the term “indigenous,” as used in the context of pozzolan, means that the pozzolan is sourced from a natural location. The alkali activated binders, and specifically concretes formed using these binders, may have considerable structural strength, thus making them highly useful for cast in-situ structural applications. For example, the alkali activated binder of the present disclosure, or concrete thereof, may replace all, or a large portion of, the cement content present in the cementitious binder of conventional curable materials such as alkali activated binders, thus significantly reducing CO₂ emissions of producing the binder. Additionally, the alkali activated binders provide an efficient and effective way of safely disposing hazardous industrial waste, such as brine sludge, thus reducing soil and groundwater contamination that occurs when disposing industrial waste in landfills.

In some embodiments, brine sludge is used to activate natural pozzolan and silico-manganese fume by substituting for sodium hydroxide as an alkaline activator. The resulting alkali activated binder has multiple benefits, including the effective utilization of industrial waste, conservation of land currently being used for disposal, and curbing of greenhouse gas emissions caused by production of cement and caustic soda.

Advantages of a brine sludge activated natural pozzolan based alkali activated binder (AAB), as described herein, include:
i. Brine sludge, an industrial waste material, can be used as a component in the alkaline activator to activate natural pozzolan for the synthesis of AAB.
ii. The AAB is environmentally friendly as it replaces almost the entire cement content of traditional binders, where cement content is highly energy intensive generating significant greenhouse gases.
iii. The AAB is a cost-effective material.
iv. The AAB can be utilized for several applications, including structural and non-structural purposes.
v. The developed concrete may be utilized in widespread industrial applications.
vi. The use of the AAB promotes effective utilization of industrial waste and conservation of land currently being used for the disposal of environmentally hazardous materials.

Some embodiments of the present disclosure relate to compositions and methods of preparing a brine sludge activated, natural pozzolan and SiMnF based alkali activated binder (AAB). Specifically, in some embodiments, brine sludge and sodium silicate are used to activate a binary precursor material comprising natural pozzolan and silico-manganese fume. The binary precursor material may comprise 50-80 wt % natural pozzolan and 20-50 wt % SiMnF, such as about 70 wt % natural pozzolan and about 30 wt % SiMnF. In some embodiments, the natural pozzolan and SiMnF based alkali activated binder has good workability and a compressive strength after 28 days of room temperature curing of 45-50 MPa, such as about 48.15 MPa. In some embodiments, the compressive strength further increases to 50-60 MPa after 90 days of curing, such as about 56.25 MPa.

In some embodiments, the developed concrete mixes of some embodiments can replace all, or almost the entire cement content used in traditional cementitious binders, which can significantly reduce the carbon footprint of the cement and concrete industries. The concretes of some embodiments can replace 50% or more of the cement relative to a traditional concrete, such as 60% or more, 70% or more, 80% or more, 90% or more, 95% or more, or 100%.

Some embodiments of the present disclosure relate to a method of producing concrete. The method may include mixing natural pozzolan, silico-manganese fume, a coarse aggregate, and a fine aggregate to form a dry powder.

The mixing is not particularly limited, and ways of mixing concrete are known to the person of ordinary skill in the art. The mixing may be accomplished using a paddle-wheel mixer, a batch mixer, a drum mixer, a tilting-drum mixer, a reversing drum mixer, a continuous mixer, or a twin-shaft mixture. The ingredients may be mixed together in any particular order. For example, the coarse and fine aggregates first may be added to the mixer first, followed by the activated natural pozzolan and the silico-manganese fume. Other ingredients, for example water, may be added to the mixing of the alkali activated binder, to the mixing of the coarse aggregate and the fine aggregate, or the mixing of the binder and the aggregates.

The coarse aggregate is not particularly limited, and may include any granular material used in construction, such as crushed rock or other naturally occurring material. Generally, a coarse aggregate may be categorized as having particles larger than a No. 4 sieve, such as larger than 3/16 inches, and less than 2 inches. In some embodiments, the coarse aggregate comprises crushed limestone. The crushed limestone may have a specific gravity of 2.4-2.8 g/cc, a water absorption of 1-3%, or both. For example, the crushed limestone may have a specific gravity of 2.5-2.7 g/cc, such as 2.55-2.65 g/cc, such as about 2.6 g/cc. The crushed limestone may have a water absorption of 2-3%, such as 2-2.5%, such as about 2.2%.

The fine aggregate is not particularly limited, and may include sand, small particles of crushed stone, or crushed slag. Generally, a fine aggregate may have particle sizes that are 0.25 inches or smaller. In some embodiments, the fine aggregate can comprise dune sand. The dune sand may have a specific gravity of 2.4-2.8 g/cc, a water absorption of 0.2-1%, and/or a fineness of 1.5-2.0. For example, the dune sand may have a specific gravity of 2.5-2.7 g/cc, such as 2.5-2.6 g/cc, such as about 2.56 g/cc. The dune sand may have a water absorption of 0.25-0.75%, such as 0.5-0.6%, such as about 0.5%. The dune sand may have a fineness modulus of 1.6-1.9, such as 1.8-1.9, such as about 1.84.

In some embodiments, the method of producing concrete may include mixing an alkaline activator with the dry powder to form the concrete, the alkaline activator comprising sodium silicate and brine sludge.

In some embodiments, the sodium silicate may include about 25-35 wt % SiO₂, 10-20 wt % Na₂O, and 40-70 wt % H₂O. The sodium silicate may have a SiO₂/Na₂O ratio of 2.0 to 3.0, and a specific gravity of 1.25-1.75 g/cc. For example, the SiO₂ component may be 30-35 wt %, such as 30-32 wt %, such as about 31.5 wt %. The Na₂O component may be about 13-15 wt %, such as about 14.0%. The H₂O component may be about 50-60 wt %, such as about 55 wt %. The SiO₂/Na₂O ratio may be from 2.0-2.5, such as about 2.25. The specific gravity may be from 1.4-1.6 g/cc, such as about 1.5 g/cc.

In some embodiments, a density of the brine sludge may be from about 100 to about 150 kg/m³. For example, the density of the brine sludge may be about 150 kg/m³, about 140 kg/m³, about 130 kg/m³, about 120 kg/m³, about 110 kg/m³, or about 100 kg/m³. A ratio of the sodium silicate to the brine sludge may be about 2.5 to 1 by mass, such as about 3.0 to 1 by mass, 2.75 to 1 by mass, 2.25 to 1 by mass, or 2 to 1 by mass. An oxide composition of the brine sludge may include 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114. ASTM C114 (2016), Standard Test Methods for Chemical Analysis of Hydraulic Cement, Annual Book of ASTM Standards, American Society for Testing and Materials, West Conshohocken, PA (the entirety of which is herein incorporated by reference).

For example, the CaO composition may be 18-19 wt %, such as 18.8 wt % or 18.9 wt %. The MgO composition may be 3-5 wt %, such as 4-5 wt %, or about 4.35 wt %. The SrO composition may be 1-1.5 wt %, such as 1-1.25 wt %, such as about 1.11 wt %. The Fe₂O₃ composition may be 1-1.5 wt %, such as about 1.1 wt % or about 1.2 wt %. The SiO₂ composition may be 0.75-1.0 wt %, such as 0.8-0.9 wt %, such as about 0.89 wt %. The SO₃ composition may be 0.25-0.3 wt %, such as 0.27-0.3 wt %, such as about 0.29 wt %. The Na₂O composition may be 14-15 wt %, such as 14.0-14.5 wt %, such as about 14.36 wt %. The BaO composition may be 8-9 wt %, such as 8.5-9 wt %, such as about 8.58 wt %. The Al₂O₃ composition may be 3-3.5 wt %, such as 3.1-3.3 wt %, such as about 3.25 wt %. The K₂O composition may be 0.5-1 wt %, such as 0.5-0.75 wt %, such as about 0.66 wt %. The Cl composition may be 6-7 wt %, such as 6.5-7 wt %, such as about 6.66 wt %. The loss on ignition (LOI) may be 38-40%, such as 39-40%, such as about 39.9%.

In some embodiments, the brine sludge may be at least partially crystalline. The brine sludge may comprise one crystalline phase, or may include multiple crystalline phases therein. The brine sludge may be at least partially crystalline, and may include one or more main crystalline phases such as calcium carbonate in a form of calcite and aragonite, sodium chloride in a form of halite, magnesium hydroxide in a form of brucite, and quartz, determined according to x-ray diffraction (XRD). For example, the brine sludge may have a crystalline calcium carbonate phase of 10-30 wt %, relative to the total weight of the brine sludge, such as 10-20 wt %, such as 15-20 wt %, such as about 18 wt % or about 18.88 wt %. The brine sludge may have a crystalline sodium chloride phase, relative to the total weight of the brine sludge, of 1-30 wt %, such as 1-10 wt %, such as 2-6 wt %. The brine sludge may have a crystalline magnesium hydroxide phase, relative to the total weight of the brine sludge, of 0-30 wt %, such as 1-10 wt %.

The brine sludge may have a total crystalline component of 0-100 wt %, such as 0-50 wt %, or 50-100 wt %, such as 30-50 wt %, 50-70 wt %, 70-90 wt %, or 90-100 wt %, with the remainder being made up on non-crystalline phases, including amorphous phases and/or liquid phases.

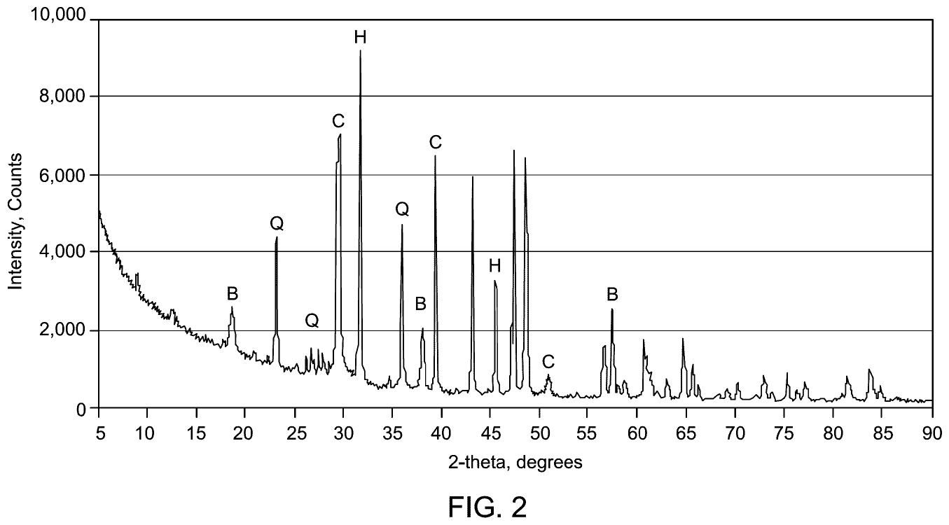

In some embodiments, the brine sludge may have an X-ray diffraction (XRD) pattern as shown in FIG. 2. FIG. 2 shows a brine sludge XRD pattern for a brine sludge having four main crystalline phases: brucite (peaks indicated as “B” in FIG. 2), quartz (peaks indicated as “Q”), calcite (peaks indicated as “C”), and halite (peaks indicated as “H”). The XRD pattern shows three sharp peaks at 20 values of approximately 18°, 37°, and 57°, indicating the presence of brucite. The XRD also shows two sharp peaks at 20 values of approximately 24° and 36°, and a more diffuse set of peaks clustered at approximately 27°, indicating the presence of quartz in the brine sludge. The sharp quartz peak heights are approximately twice as high as the brucite peak heights. The XRD pattern also shows two sharp peaks at 2θ values of 32° and 46°, indicating the presence of halite in the brine sludge. The halite peak at 32° is the tallest peak in the spectrum, indicating a large relative component of NaCl in the form of halite in the brine sludge. The XRD pattern also shows two sharp peaks at approximately 29° and 51°, which indicates the presence of calcite in the brine sludge. In some embodiments, the XRD pattern may have additional sharp peaks indicating additional crystalline components which do not correspond to any of brucite, quarts, calcite, or halite, such as the two peaks at approximately 47°-48° shown in FIG. 2, or the multiple clusters of short peaks shown above 60° in FIG. 2.

In some embodiments, a ratio of the natural pozzolan to the silico-manganese fume is from about 80:20 to about 60:40 by mass, such as about 75:25 by mass, 70:30 by mass, 65:35 by mass, or 60:40 by mass.

In some embodiments, the concrete formed may have a compressive strength of at least 40 MPa, such as at least 45 MPa, at least 50 MPa, at least 55 MPa, at least 60 MPa, at least 65 MPa, at least 70 MPa, or higher.

The concrete may have a flexural strength of from 2.5 MPa to 7.5 MPa, such as about 3 MPa, about 5 MPa, or about 7 MPa. The concrete may have a modulus of elasticity from 6 GPa to 35 GPa, such as about 10 GPa, about 15 GPa, about 20 GPa, about 25 GPa, about 30 GPa, or about 35 GPa. In some embodiments, the modulus of elasticity is about 27.7 GPa,

In some embodiments, the concrete may have a 28-day drying shrinkage strain of 600 μs or less, such as 550 μs or less, 500 μs or less, 475 μs or less, or 450 μs or less. In some embodiments, the average drying shrinkage may be about 484 μs, about 537 μs, or about 579 μs.

The alkali activated binder may have an initial setting time of 45 minutes or more. The alkali activated binder may have an average compressive strength of at least 9.5 MPa, such as at least 10 MPa, at least 15 MPa, or at least 20 MPa.

The concrete may have a final setting time of 320 minutes or less, such as 300 minutes or less, or 290 minutes or less, such as about 286 minutes. The setting times of the concrete may conform to the ASTM C150 standards for conventional cementitious materials. ASTM C150 (2016), Standard Specification for Portland Cement Importance of the disclosure, Annual Book of ASTM Standards, American Society for Testing and Materials, West Conshohocken, PA (the entirety of which is incorporated herein in its entirety). In some embodiments, the average initial setting time is about 150 minutes or less, such as about 140 minutes.

In some embodiments, the method of forming the concrete may include curing the concrete. The curing may include a one-day heat curing, at approximately 60° C. to 80° C., such as 70° C., followed by a room-temperature curing for at least six days, such as about 10 days, about 20 days, about 30 days, about 60 days, about 90 days, or longer. In some embodiments, the curing may include a continuous curing at a temperature of 21° C. to 25° C. and a humidity of 45% to 55%. The continuous curing may occur for 6 days, about 10 days, about 20 days, about 30 days, about 60 days, about 90 days, or longer.

Numerous modifications and variations of the present disclosure are possible in light of the above teachings. It is therefore to be understood that within the scope of the appended claims, the invention may be practiced otherwise than as specifically described herein.

### EXAMPLES

### Example 1: Preparation of Brine Sludge Activated Natural Pozzolan and Silico-Manganese Fume Binders and Concretes Thereof

In this example, brine sludge (BS) was used to activate a natural pozzolan (NP) and silico-manganese fume (SiMnF) based alkaline activated binder (AAB).

### Materials

SiMnF used in the current disclosure was obtained from Gulf Ferro alloys company (SABAYEK), Jubail, Saudi Arabia. The SiMnF was spherical in morphology, as shown in FIG. 1. Its physical appearance was reddish brown, having a specific gravity of about 2.87 g/cc. The physical properties and chemical composition of the SiMnF are shown in Table 1 and Table 2, respectively.

TABLE 1
Physical properties of silico-manganese fume.

| Property | Value | |
|---|---|---|
| BET surface area | 8.12 | m²/g |
| Average particle size | 25.51 | μm |
| Moisture content | 0.325% | mg/L |

| | |
|---|---|
| Strength activity index | 76.7% |

TABLE 2
Chemical composition and loss on ignition
(LOI) of silico-manganese fume.

| Chemical composition | Weight (%) |
|---|---|
| Silica (SiO₂) | 14.57 |
| Alumina (Al₂O₃) | 1.24 |
| Ferric Oxide (Fe₂O₃) | 2.37 |
| Lime (CaO) | 4.61 |
| Magnesium Oxide (MgO) | 4.78 |
| Potassium Oxide (K₂O) | 27.25 |
| Sulfur Trioxide (SO₃) | 6.16 |
| Manganese oxide (MnO) | 33.13 |
| Sodium oxide (Na₂O) | 1.64 |
| Chloride (Cl) | 3.28 |
| Zinc Oxide (ZnO) | 0.73 |
| Loss on Ignition (LOI) | 5.70% |

Brine sludge (BS), supplied by SIPCHEM, was used to activate natural pozzolan and SiMnF as a component in the alkaline activator. The raw brine sludge was mainly composed of Calcite. The other elements include Si, Mg, Na, Ba and Cl. The XRD pattern, as shown in the FIG. 2, confirmed the crystalline nature of compounds and indicated that the main phases in brine sludge were calcium carbonate in the form of Calcite and Aragonite, Halite (Sodium Chloride), Brucite (Magnesium Hydroxide), and quartz (SiO₂). The chemical composition of the raw brine sludge is shown in Table 3, which was determined in accordance with ASTM C114.

Industrial grade sodium silicate solution, obtained from SAMACHEM located in second industrial city, Dammam, was used in the study. The chemical and physical characteristics of the sodium silicate are shown in Table 4.

For producing concrete, crushed limestone and dune sand were used as coarse and fine aggregates, respectively. The specific gravity, water absorption and fineness modulus of the dune sand were about 2.56 g/cc, about 0.5%, and about 1.84, respectively. The specific gravity and water absorption of coarse aggregate were 2.6 g/cc and 2.2%, respectively.

TABLE 3
Chemical composition and loss on ignition (LOI) of brine sludge.

| Oxides | Weight, % |
|---|---|
| CaO | 18.88 |
| MgO | 4.35 |
| SrO | 1.11 |
| Fe₂O₃ | 1.07 |
| SiO₂ | 0.89 |
| SO₃ | 0.29 |
| Na₂O | 14.36 |
| BaO | 8.58 |
| Al₂O₃ | 3.25 |
| K₂O | 0.66 |
| Cl | 6.66 |
| LOI | 39.9% |

TABLE 4
Chemical composition and physical
properties of sodium silicate (SS).

| SiO₂, % | Na₂O, % | H₂O, % | SiO₂/Na₂O | Specific Gravity, g/cc |
|---|---|---|---|---|
| 31.5 | 14.0 | 55.0 | 2.25 | 1.50 |

### Mix Details and Preparation of Concrete Specimens

Brine sludge was utilized as an activator to prepare a natural pozzolan and silico-manganese fume based alkali activated binder (NP+SiMnF based AAB). Traditionally, aluminosilicate precursor materials have been activated using alkaline materials composed of sodium silicate (SS) and sodium hydroxide (SH) solutions. However, in view of the alkaline nature of brine sludge, it was used as a component in the alkaline activator, replacing SH solution in the current invention. The mix proportions are shown in the Table 5. Alkali activated concretes (AACs) were also produced by activating natural pozzolan using sodium silicate and 12M sodium hydroxide solution, at a weight ratio of 2.5 to 1, for comparison purposes. In addition, 100% natural pozzolan was also activated using sodium silicate and brine sludge in the preparation of the AAB.

TABLE 5
Material proportions of selected AAC mixes.

| Mix | Mix | | NP, | SiMnF, | SS, | SH, | BS, | CA, | FA, |
|---|---|---|---|---|---|---|---|---|---|
| # | Details | Activator | kg/m³ | kg/m³ | kg/m³ | kg/m³ | kg/m³ | kg/m³ | kg/m³ |
| M1 | 100% NP | SS + SH | 400 | — | 150 | 60 | — | 1105 | 737 |
| M2 | 100% NP | SS + BS | 400 | — | 250 | — | 100 | 1015 | 676 |
| M3 | 70% NP + | SS + BS | 280 | 120 | 250 | — | 100 | 982 | 655 |
| | 30% SMF | | | | | | | | |

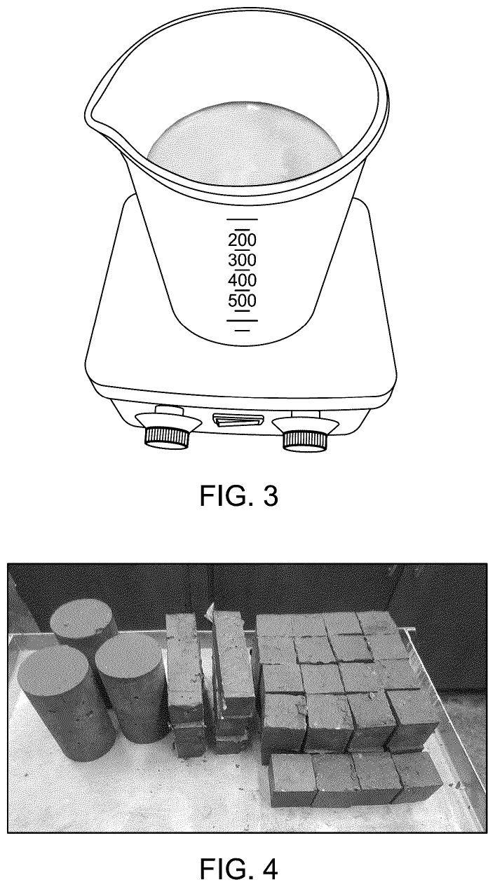

The liquid portion of the AAC mix was prepared prior to adding the required quantity of the brine sludge to the sodium silicate solution and thoroughly mixed, as depicted in FIG. 3. For the preparation of concrete specimens, the required quantities of coarse and fine aggregates were weighed, and placed in a paddle mixer to which the precursor material was added. These materials were dry mixed thoroughly, followed by the addition of alkaline activator. Every material added to the bowl was mixed for approximately 1 to 2 minutes, such that the total mixing time was about 5 to 6 minutes, to ensure the homogeneity of the mixture. Subsequently, the concrete was placed in molds in two layers, and each layer was vibrated for 30 seconds to remove the entrapped air. Then, the surface was carefully finished to a smooth surface using a trowel. The molded specimens were covered with a plastic sheet to prevent moisture loss, and kept in the laboratory atmosphere maintained at 23+/−2° C. for 24 hours, before being de-molded.

FIG. 4 shows the demolded specimens. The specimens for measuring compressive strength were divided into two groups. The first group was cured for 1 day in an oven at 70° C., and subsequently cured under laboratory conditions maintained at a temperature and humidity of 23+/−2° C. and 50+/−5%, respectively, until testing at the predetermined age. The second group of specimens were continuously cured under the laboratory conditions until testing age.

### Example 2: Physical Characterization of Brine Sludge Activated Natural Pozzolan and Silico-Manganese Fume Concretes

### Methods

Alkaline activated concrete specimens were prepared from the mixes shown in Table 5, and tested to determine the following properties of the concrete specimens.

a. Setting time; according to ASTM C191 ASTM C191 (2016), Standard Test Methods for Time of Setting of Hydraulic Cement by Vicat Needle, Annual Book of ASTM Standards, American Society for Testing and Materials, West Conshohocken, PA (the entirety of which is herein incorporated by reference in its entirety).

b. Flow of mortar; according to ASTM C1437. ASTM C1437 (2016), Standard Test Method for Flow of Hydraulic Cement Mortar, Annual Book of ASTM Standards, American Society for Testing and Materials, West Conshohocken, PA (the entirety of which is herein incorporated by reference in its entirety).

c. Compressive strength; according to ASTM C39. 4.ASTM C39 (2016), Standard Test Method for Compressive Strength of Cylindrical Concrete Specimens, Annual Book of ASTM Standards, American Society for Testing and Materials, West Conshohocken, PA (the entirety of which is herein incorporated by reference in its entirety).

d. Flexural strength; according to ASTM C78. ASTM C78 (2016), Standard Test Method for Flexural Strength of Concrete (Using Simple Beam with Third-Point Loading), Annual Book of ASTM Standards, American Society for Testing and Materials, West Conshohocken, PA (the entirety of which is herein incorporated by reference in its entirety).

e. Modulus of elasticity; according to ASTM C469. ASTM C469 (2016), Standard Test Method for Static Modulus of Elasticity and Poisson's Ratio of Concrete in Compression, Annual Book of ASTM Standards, American Society for Testing and Materials, West Conshohocken, PA (the entirety of which is herein incorporated by reference in its entirety).

f. Drying shrinkage; according to ASTM C157. ASTM C157 (2016), Standard Test Method for Length Change of Hardened Hydraulic-Cement Mortar and Concrete, Annual Book of ASTM Standards, American Society for Testing and Materials, West Conshohocken, PA (the entirety of which is herein incorporated by reference in its entirety).

### Results

### Setting Times and Workability

Table 6 shows initial, final, and average setting times for different alkali activated mixtures. The average initial and final setting times of 100% NP activated concrete, using a conventional alkaline activator comprising SS and 12M SH, were 144 and 281 minutes, respectively. However, there was a marginal decrease in the initial and final setting times when the 100% NP was activated using SS and BS, of about 139 min and 276 minutes, respectively. The marginal decrease in the setting time may have been due to the alkalinity of BS. The 70% NP+30% SiMnF mixture had initial and final setting times of 140 and 286 minutes, respectively. ASTM C150 specifies that the initial setting time should be more than 45 minutes while the final setting time should not be more 375 minute for conventional cementitious materials. Hence, the initial and final setting time measured for the various mixes evaluated in this study were within the range specified by ASTM C150.

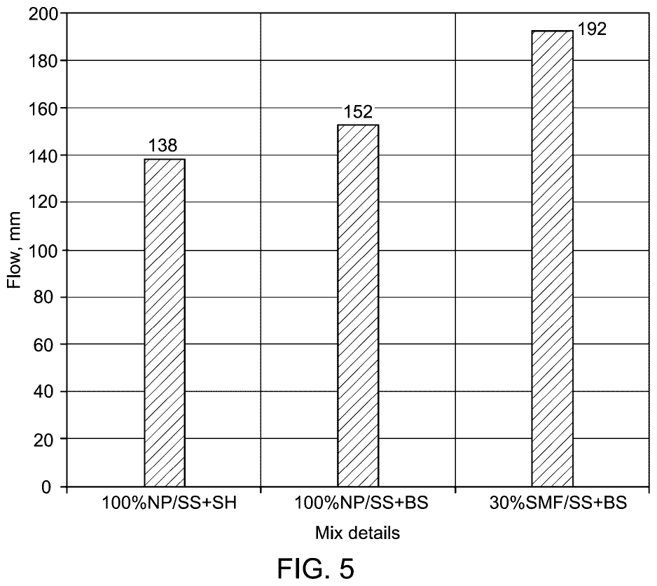

The flow of various mixtures is shown in FIG. 5. Generally, the workability of all the mixtures was good. The flow ranged from 138 to 192 mm. The lowest flow was recorded in the mixture containing 100% NP activated using SS+SH, whereas, the highest flow was observed in a mix incorporating 30% SMF. The better workability in the 30% SiMnF may be due to the spherical morphology of the SiMnF.

TABLE 6
Setting time of alkali activated mixtures.

| | | | Setting time, minutes | | | | | |
|---|---|---|---|---|---|---|---|---|
| Mix | Mixture | | Specimen 1 | | Specimen 2 | | Average | |
| # | composition | Activator | Initial | Final | Initial | Final | Initial | Final |
| M1 | 100% NP | SS + SH | 145 | 273 | 143 | 288 | 144 | 281 |
| M2 | 100% NP | SS + BS | 140 | 270 | 138 | 281 | 139 | 276 |
| M3 | 70% NP + | SS + BS | 139 | 283 | 140 | 288 | 140 | 286 |
| | 30% SMF | | | | | | | |

### Evolution of Compressive Strength

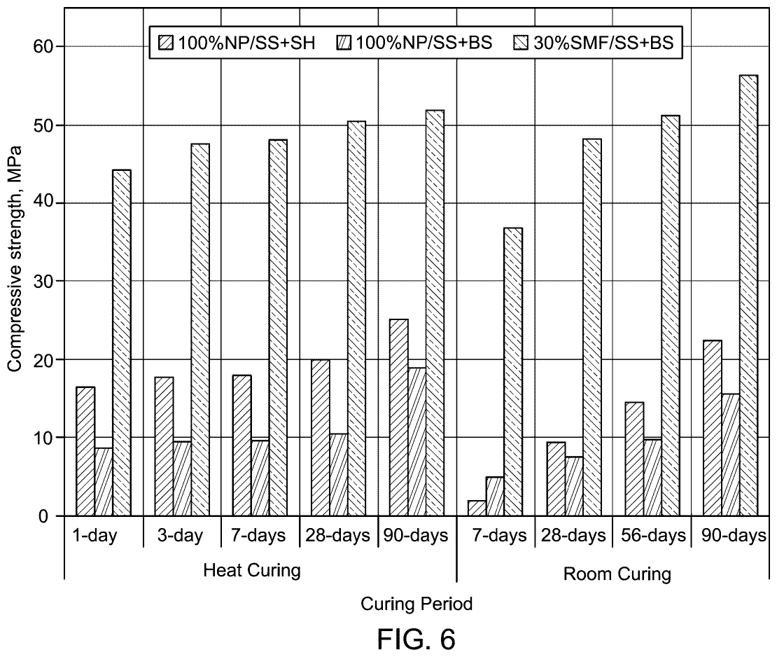

The specimens prepared to determine compressive strength of concrete were divided into two batches. The first batch of specimens was cured for one day at 70° C. in the oven. Subsequently, the compressive strength was determined at 1, 3, 7, 28, and 90 days. This curing regime was termed heat curing. The other batch of specimens was cured at room temperature, by continuously keeping them under laboratory conditions maintained at a temperature and relative humidity of 23+/−2° C. and 50+/−5%, respectively. Subsequently, the compressive strength was determined at 7, 28, 56, and 90 days. This curing regime was termed room temperature curing. FIG. 6 depicts the compressive strength development of heat cured as well as room temperature cured AAC specimens.

In general, the gain in compressive strength was faster in the AAC specimens heat cured in the oven for 1 day, compared to specimens that were room temperature cured. The NP activated using conventional activators SS and SH resulted in a compressive strength of about 19.81 MPa when heat cured, and 9.33 MPa when cured continuously at room temperature. This shows that there was nearly a two-fold strength increase in the heat cured specimens. However, when brine sludge was used as a component in the alkaline activator, the compressive strength development in the precursor having 100% NP was slower in the specimens cured under both curing regimes. However, significant improvement was observed when the NP was replaced with 30% SiMnF. 28-days compressive strengths of 10.30 and 7.43 MPa were observed in the 100% NP activated using SS and BS, heat cured and room temperature cured, respectively. 90-days compressive strengths of 18.89 and 15.44 MPa were observed in the same mixtures when heat cured and room temperature cured, respectively.

The binary AAC mixtures of 70% NP+30% SiMnF achieved significantly high strengths when cured under either curing regime. This mixture was prepared by activating a precursor comprising 70% NP+30% SiMnF and utilizing SS and BS activator. The compressive strength obtained after 1 day of heat curing was 44.13 MPa, whereas it was 36.76 MPa after 7 days of room temperature curing. 90-days heat cured and room temperature cured (1 day heat cured+89 days room temperature cured) 70% NP+30% SiMnF based AACs yielded compressive strengths of about 56.25 and 51.85 MPa, respectively. Thus, the room temperature curing resulted in better compressive strengths. These values also show that there was more than a two-fold improvement in the compressive strength, compared to an AAC mixture prepared by activating 100% NP using SS+SH. The significant improvement in the compressive strength of SiMnF incorporation may be due to improved dissolution of the precursor materials, thereby possibly enhancing the polymerization process. The AACs of the present disclosure, including natural pozzolan and SiMnF-based AACs, are suitable for cast in-situ applications, such as any general application of cast in-situ (also known as cast in-place) traditional concrete having similar compressive strength, workability, and other properties. For example, non-limiting examples of suitable applications of the AACs described herein include foundations, including foundations of buildings, walls, slabs, ceilings, including reinforced concrete ceilings, bridges and bridge columns, concrete piles, including concrete piles poured in steel shells, underground applications, and underwater applications. In some embodiments, the AAC may be poured into the cast in-situ application, such as any of the applications described herein. Furthermore, the embodiments described herein are suitable to being scaled up to any levels.

### Flexural Strength and Modulus of Elasticity

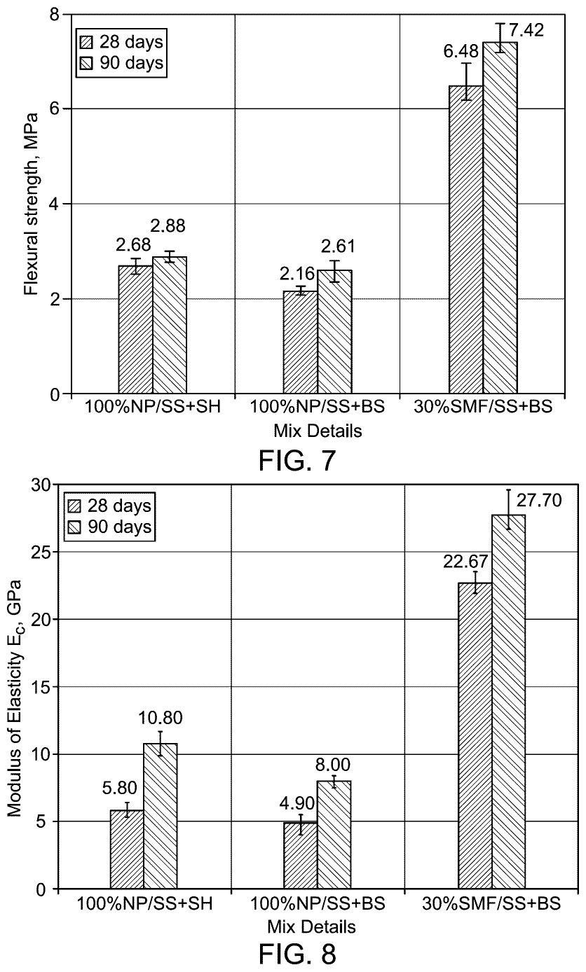

FIG. 7 and FIG. 8 display the flexural strength and modulus of elasticity, respectively, of AAC mixtures prepared using brine sludge. The testing of these specimens was carried out after curing continuously under room temperature conditions. The 90 days flexural strengths of the resulting AACs were in the range of from 2.61 to 7.42 MPa. The lowest value was observed in the 100% NP activated with SS+BS, while the highest was observed in the 70% NP+30% SiMnF composition. A similar trend was noted in the modulus of elasticity data. The modulus of elasticity of the developed AACs, after 90 days of room temperature curing, was in the range of from 8.0 to 27.7 GPa.

### Drying Shrinkage

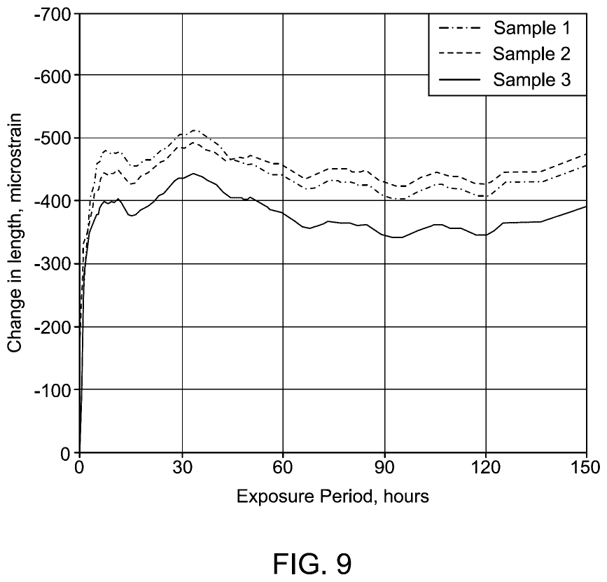

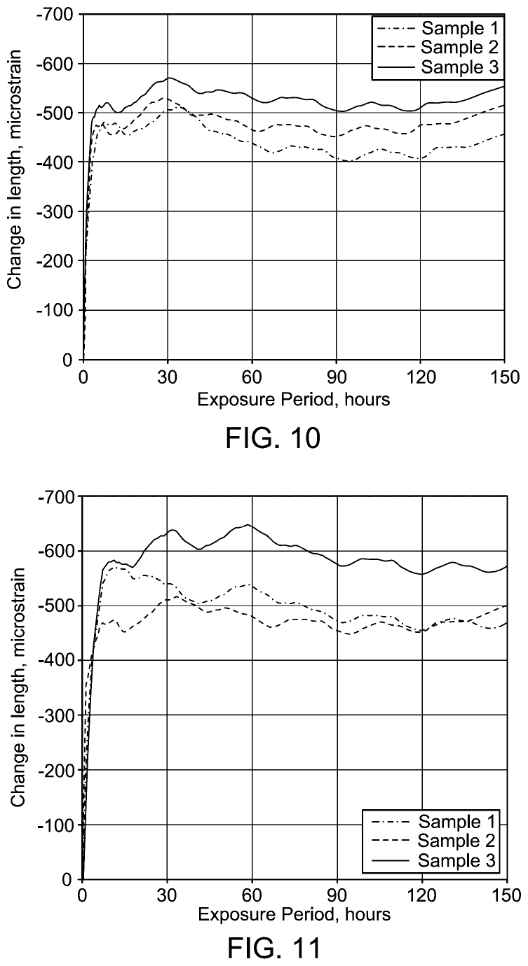

FIGS. 9, 10, and 11 show the drying shrinkage strain in the AAC mixes comprising 100% NP activated with SS+SH, 100% NP activated with SS+BS, and 70% NP+30% SiMnF activated with SS+BS, respectively. After initial curing for 7 days, the specimens were subjected to drying under laboratory conditions maintained at a temperature and relative humidity of 23+/−2° C. and 50+/−5%, respectively. Generally, the rate of drying shrinkage was rapid during the first seven days of exposure. Subsequently, there was no significant increase in the drying shrinkage rate. However, the maximum drying shrinkage was recorded after one month of exposure. After this period, there was a fluctuation in the drying shrinkage values.

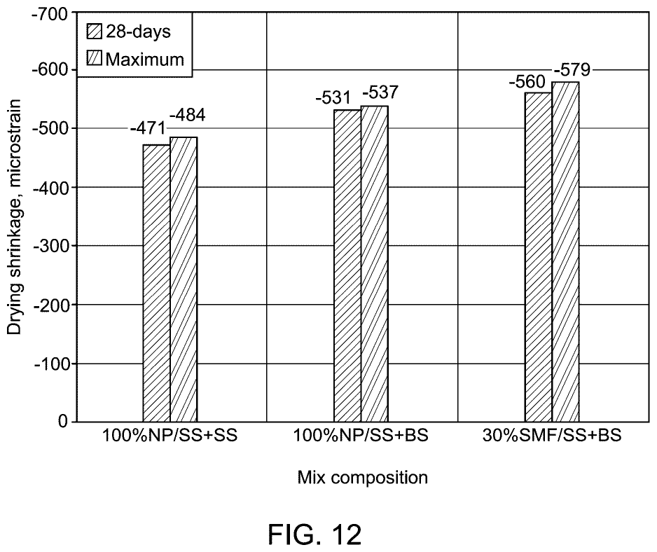

FIG. 12 depicts the maximum and 28-days drying shrinkage strains measured in the various mixes. The results show that the inclusion of brine sludge as an alkaline activator increased the drying shrinkage strain. This may be due to the alkaline nature and fineness of BS. The average maximum drying shrinkages were 484, 537, and 579, micro-strains (με) in the mixes 100% NP activated with SS+SH, 100% NP activated with SS+BS, and 70% NP+30% SiMnF activated with SS+BS, respectively. The maximum drying shrinkage strains were observed in the mixtures comprising 70% NP+30% SiMnF. The 28-day drying shrinkage strain was in a range from 500 to 600 μs in most of the AAC mixtures prepared by activating the precursor using SS and BS. Generally, a 28-days drying shrinkage strain ranging between 500 to 600 μs is allowable in accordance with the ASTM C157, in order to avoid cracking of the concrete. Usually, blended cements cause higher drying shrinkage owing to the fineness. Due to the highly alkaline nature of the brine sludge and its fineness may have been factors contributing to a marginal increase in the drying shrinkage strain. However, the drying shrinkage strain rate was within acceptable limits.

In summary, brine sludge was used as a component in the alkaline activator, replacing sodium hydroxide solution in the AAB. About 100 kg/m³ of BS, with a SS/BS ratio of 2.5 to 1, was found to activate natural pozzolan with good workability and reasonably high compressive strength. The natural pozzolan activated using conventional activators, including SS and SH, resulted in a compressive strength of about 19.81 MPa when heat cured, and 9.33 MPa in the specimens when continuously room cured.

28-days compressive strengths of 10.30 and 7.43 MPa were observed in the 100% NP AAC activated using SS and BS, for heat and room temperature cured conditions, respectively. The 90-days compressive strengths were about 18.89 and 15.44 MPa when heat cured and room temperature cured, respectively. Significant improvement in the compressive strengths of AACs was observed when 70% NP+30% SiMnF was activated using sodium silicate and brine sludge. The compressive strengths were nearly 51.85 and 56.25 MPa after 90 days of curing, in heat cured and room temperature cured conditions, respectively.

The compressive strengths obtained in the NP+SiMnF based AACs, especially with room temperature curing, were sufficiently to be suitable for structural applications of cast in-situ concrete, and can be scaled up for mass production. Furthermore, the maximum drying shrinkage strain of the concretes was within acceptable limits.

1. A method of producing concrete, comprising:
mixing natural pozzolan, silico-manganese fume, a coarse aggregate, and a fine aggregate to form a dry powder; and
mixing an alkaline activator with the dry powder to form the concrete, the alkaline activator comprising sodium silicate and brine sludge,
wherein:
a density of the brine sludge is about 100 kg/m³ or more,
a ratio of the sodium silicate to the brine sludge is about 2.5 to 1 by mass, and
an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

2. The method of claim 1, wherein a ratio of the natural pozzolan to the silico-manganese fume is about 70:30 by mass.

3. The method of claim 1, wherein the concrete has a compressive strength of 48 MPa or more.

4. The method of claim 1, wherein the concrete has a flexural strength of 2.5 MPa to 7.5 MPa.

5. The method of claim 1, wherein the concrete has a modulus of elasticity of 8.0 GPa to 30 GPa.

6. The method of claim 1, wherein the silico-manganese fume comprises particles having a spherical morphology.

7. The method of claim 1, wherein the silico-manganese fume has a specific gravity of 2.5 g/cc to 3.0 g/cc.

8. The method of claim 1, wherein the silico-manganese fume has a BET surface area of 8-8.5 m²/g, an average particle size of 22-27 μm, a moisture content of 0.1-0.5%, and a strength activity index of 72-78%.

9. The method of claim 1, wherein the brine sludge is crystalline, comprising main phases of calcium carbonate in a form of calcite and aragonite, sodium chloride in a form of halite, magnesium hydroxide in a form of brucite, and quartz, determined according to x-ray diffraction (XRD).

10. The method of claim 1, wherein the coarse aggregate comprises crushed limestone having a specific gravity of 2.4-2.8 g/cc and a water absorption of 2.0-2.4%.

11. The method of claim 1, wherein the fine aggregate comprises dune sand having a specific gravity of 2.4-2.8 g/cc, a water absorption of 0.25-1%, and a fineness of 1.7-2.0.

12. The method of claim 1, wherein the concrete has a flow of from 130 mm to 200 mm.

13. The method of claim 1, wherein the concrete has a 28-day drying shrinkage strain of 600με or less.

14. The method of claim 1, further comprising:
pouring the concrete in a cast in-situ structural application,
wherein the concrete has an average initial setting time of 144 minutes or less and an average final setting time of 290 minutes or less.

15. The method of claim 1, further comprising curing the concrete, wherein the curing comprises a one-day heat curing at approximately 70° C., followed by a room temperature curing for at least six days.

16. The method of claim 1, further comprising curing the concrete, wherein the curing comprises a continuous curing at a temperature of 21° C. to 25° C. and a humidity of 45% to 55%.

17. An alkali activated binder, comprising:
natural pozzolan;
silico-manganese fume; and
an alkali activator comprising sodium silicate and brine sludge,
wherein:
a density of the brine sludge is about 100 kg/m³ or more,
a ratio of the sodium silicate to the brine sludge is about 2.5 to 1 by mass, and
an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

18. The alkali activated binder of claim 17, wherein a ratio of the natural pozzolan to the silico-manganese fume is about 70:30 by mass.

19. A concrete, comprising:
the alkali activated binder of claim 17;
a coarse aggregate comprising crushed limestone; and
a fine aggregate comprising dune sand.

20. The concrete of claim 19, having a compressive strength of 48 MPa or more.
